(19) United States
(12) Patent Application Publication
(10) Pub. No.: US 2013/0306178 A1
(43) Pub. Date: Nov. 21, 2013

(54) Pressure Relief Valve Arrangement for a Fuel Line

(71) Applicant: VERITAS AG, Gelnhausen (DE)

(72) Inventor: Isa Coel, Frankfurt (DE)

(73) Assignee: Veritas AG, Gelnhausen (DE)

(21) Appl. No.: 13/789,195

(22) Filed: Mar. 7, 2013

(30) Foreign Application Priority Data
May 15, 2012 (DE) 10 2012 208 110.0

(51) Int. Cl. F02M 63/00

(52) U.S. Cl. CPC F02M 63/005
USPC 137/861

(57) ABSTRACT

The present invention concerns a pressure control valve system 100 for a fuel line 101 with a main fuel section 103, that can be closed with a first spring-loaded sealing body 105 for maintaining a fuel pressure in the fuel line 101, whereby the first sealing body 105 comprises a sealing body head 107 for sealing the main fuel line 103, that can be pressed with spring force again a sealing seat, an auxiliary fuel line 109, which is formed in the first spring loaded sealing body 105 for filling the fuel line 101 with fuel, and second spring-loaded sealing body 111, which is provided for sealing the auxiliary fuel line 109.

The present invention concerns a pressure control valve system for a fuel line.

In modern internal combustion engines, the injection valves of the internal combustion engine are supplied with fuel through a common fuel line (common rail system). Fuel that is not introduced into the particular injection valves is collected in a common fuel return line and is introduced again into a fuel inlet line.

In order to insure the function of the injection valves, a constant fuel pressure is maintained in the fuel return line with the aid of a pressure control valve. Before the initial operation of the internal combustion engine, the fuel return line is filled with fuel.

Publication DE 103 39 250 A1 describes a pressure control valve that can be used for maintaining the fuel pressure in a fuel line as well as for filling the fuel line.

The task of the invention is to simplify the structure of a pressure control valve.

This task is achieved by means of an object with characteristics in accordance with the independent claim. Advantageous embodiments are the objects of the dependent claims, of the description and the diagrams.

The present invention is based on the recognition that the structure of the present pressure control valves is complicated and prone to defects.

According to one embodiment, the task of the invention is achieved by a pressure control valve system for a fuel line with a main fluid section that can be closed with the aid of a first spring-loaded sealing body for the purpose of maintaining a fuel pressure in the fuel line; whereby the first sealing body comprises a sealing body head that can be pressed with a spring loading against a valve seat for sealing the main fuel line, an auxiliary fuel line, which is designed to fill the fuel line with fuel in the first spring-loaded sealing body, and a second spring-loaded sealing body, which is provided to close the auxiliary fuel line. One achieves thereby, for example, the technical advantage that the main fuel line can be closed reliably and the functioning of the pressure control valve system is improved. In addition, with the aid of the pressure control valve system according to the invention, an especially compact structure of the pressure control valve can be realized.

In one advantageous embodiment of the pressure control valve system, the auxiliary fuel line is designed as an axial bore through the first spring-loaded sealing body. One achieves thereby, for example, the technical advantage that a straight section can be realized for filling the fuel line.

In a further advantageous embodiment of the pressure control valve system, the first spring-loaded sealing body comprises a cylindrical shaft that turns into the sealing body head, and a spring that surrounds the cylindrical shaft and acts on the sealing body head. One achieves thereby, for example, the technical advantage that the structure of the pressure control valve becomes simplified. Due to the cylindrical shape of the shaft, a tilting of the sealing body is prevented.

In a further advantageous embodiment of the pressure control valve system, the sealing body head has a mushroom shape with rotational symmetry. One achieves thereby, for example, the technical advantage that the sealing body head seals the main fuel line especially well.

In a further advantageous embodiment of the pressure control valve system, the auxiliary fuel line has a sealing seat for holding the second spring-loaded sealing body. One achieves thereby, for example, the technical advantage that an especially compact construction is obtained.

In a further advantageous embodiment of the pressure control valve system, an outer wall of the first spring-loaded sealing body has at least one axial line for the flow of fuel. One achieves thereby, for example, the technical advantage that the flow and the throughput of the fuel are improved.

In a further advantageous embodiment of the pressure control valve system, the second spring-loaded sealing body is formed by a sealing sphere. One achieves thereby, for example, the technical advantage that a sealing body is used that is especially easy to manufacture.

In a further advantageous embodiment of the pressure control valve system, a spring is provided to act on the second spring-loaded sealing body for the closing of the auxiliary fuel line. One achieves, thereby, the technical advantage that a force can be applied directly to the sealing body head for the closing of the main fuel line.

In a further advantageous embodiment of the pressure control valve system, the main fuel line, as well as the auxiliary fuel line, are formed in a housing, and the first spring-loaded sealing body and the second spring-loaded sealing body are arranged such that they can be shifted axially in the housing. Once achieves thereby, for example, also the technical advantage that an especially compact construction of the pressure control valve can be realized.

In a further advantageous embodiment of the pressure control valve system, a spring force acting on the first sealing body is smaller than the spring force acting on the second sealing body. One achieves thereby, for example, the technical advantage that the fuel line can be filled with a low fuel pressure.

In a further advantageous embodiment of the pressure control valve system, the main fuel line runs along an outer wall of the first spring-loaded sealing body. One achieves thereby, for example, the technical advantage that the fuel flow runs along the surface in a laminar fashion.

In a further advantageous embodiment of the pressure control valve system, a funnel-shaped sealing seat is formed in the sealing body head for the second spring-loaded sealing body. One achieves thereby, for example, the technical advantage that the auxiliary fuel line can be sealed especially reliably.

In a further advantageous embodiment of the pressure control valve system, the sealing body has a sealing surface against one of the walls. One achieves thereby, for example, the technical advantage that an especially reliable sealing is made possible by the sealing surface.

In a further advantageous embodiment of the pressure control valve system, a number of axial lines are provided on the first sealing body. One achieves thereby, for example, the technical advantage that the flow around the sealing body is improved even more.

In a further advantageous embodiment of the pressure control valve system, the auxiliary fuel line runs through the first sealing body. One achieves thereby, for example, the technical advantage that the structural volume of the valve is reduced.

Embodiment examples of the invention are presented in the drawing[s] and will be described in more detail below.

The following are shown:

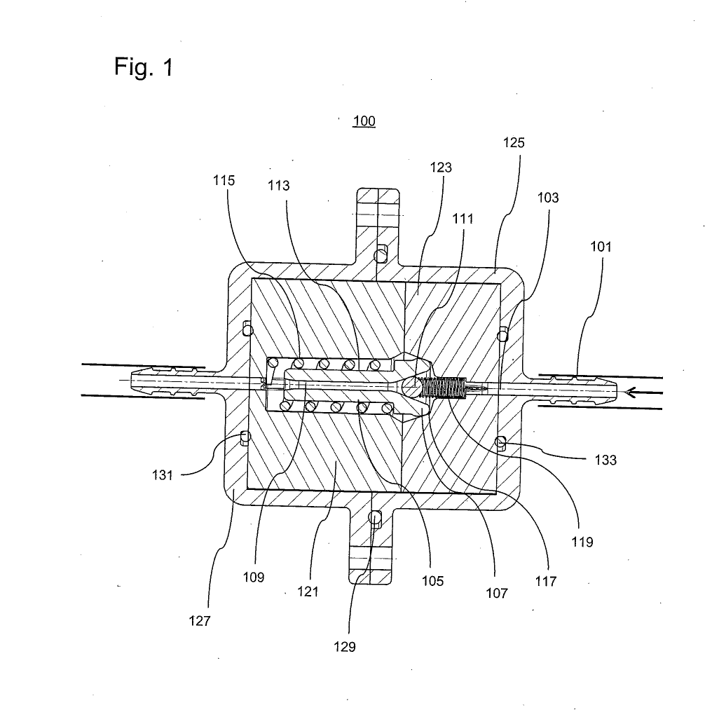

FIG. 1 is a cross-sectional view of a pressure control valve system;

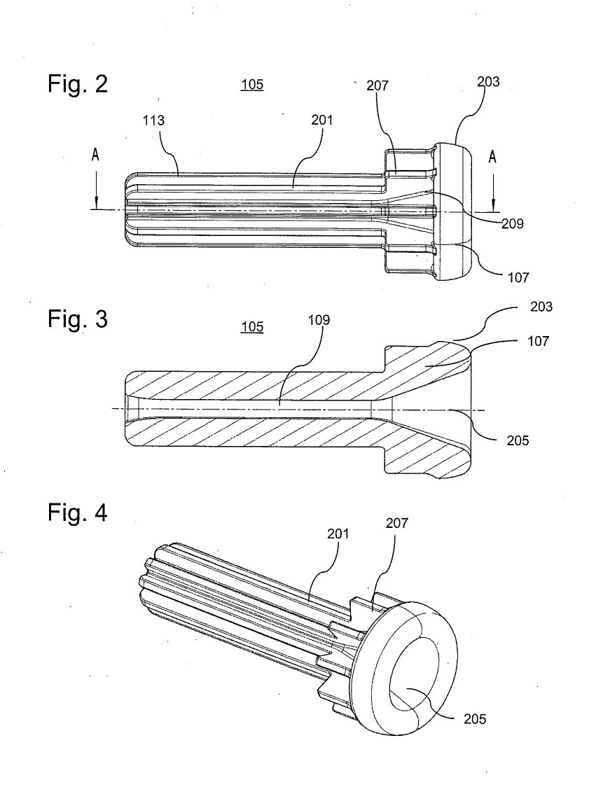

FIG. 2 is a view of a sealing body;

FIG. 3 is a cross-sectional view of the sealing body; and

FIG. 4 is a perspective view of the sealing body.

FIG. 1 shows a cross-sectional view of the pressure control valve system 100. The pressure control system 100 is connected to a fuel line 101, through which the uncombusted fuel runs back from an internal combustion engine, which is not shown, into a fuel cycle. For this reason this fuel line 101 is also called the return line. The pressure control valve system serves to maintain pressure in the fuel line 101.

The pressure control valve system 100 is especially suitable for keeping the pressure in the return flow of an internal combustion engine with piezo-injection valves in a common rail system constant, so that the function of the piezo-injection valves can be maintained and pressure fluctuations in the injection nozzles can be prevented. A common rail system refers to a diesel direct injection internal combustion engine in which all cylinders lie on a common fuel distributor line. In this distributor line, a permanent high pressure is produced, which stores the fuel and distributes it to the controlled injection nozzles. The advantages of the common rail system are improved formation of mixtures in the cylinders, lower consumption and lower emissions.

The pressure control valve system 100 comprises a main fuel line 103 through which the fuel flows in the direction of the arrow when a predetermined pressure is exceeded. The fuel line can be closed with the aid of a sealing body 105 loaded with a screw-shaped pressure spring 115 in order to maintain fuel pressure. When the pressure in the fuel line 101 exceeds a target value, the sealing body 105 moves axially to the side and opens the path for the fuel located in the fuel line 101, so that the latter can flow out from the fuel line 101. The pressure in the fuel line 101 is reduced until the target value is reached again. The spring-loaded sealing body 105 thus serves to maintain and stabilize the pressure in the fuel line 101.

The rotationally symmetrical sealing body 105 has a sealing body head 107 and a cylindrical shaft 113 against which the spring 115 lies. The spring 115 exerts a force onto the sealing body head 107 which presses the latter into the sealing seat 117. The sealing body head 107 of the sealing body 105 serves to close the main fuel line 103. The fuel pressure necessary for opening the main fuel line 103 is determined by the spring constant and by the tensioning of the spring 115. The sealing seat 117 has a cup-shaped recess, and the sealing body head 107 lies tightly against the side wall of this recess in the closed state.

In addition, the pressure control valve system 100 has an auxiliary fuel line 109, which is designed for filling the fuel line 101 with fuel in the spring-loaded sealing body 105. A sphere 111 serves as an additional sealing body for closing the auxiliary fuel line. When the larger sealing body 105 moves due to an excess pressure in the fuel line 101, the sphere 111 is held in a funnel-shaped recess within the sealing body 105 by the pressure of the fuel as well as by a spring 119. In this case the fuel flows around the sealing body 105.

During the manufacture of the vehicle or after maintenance or repair it is frequently necessary to perform an initial filling or refilling of the fuel line 101 with fuel. The initial filling or refilling with fuel is done in a filling direction that is opposite to the direction of the arrow, which indicates the main flow direction of the fuel during the operation of the combustion engine.

During the filling of the fuel line 101, the large sealing body 105 is pressed into the sealing seat 117, while the sphere 111 releases the funnel-shaped recess in the sealing body head 107 and the fuel for filling the fuel line flows through the auxiliary fuel line 109 on the inside of the sealing body 105.

In the direction of filling, the fuel, as fluid, applies a pressure to the sealing body 105 in the main fuel line 103 and thus seals the passage. At the same time the fuel applies the same pressure to the sphere 111 and opens the auxiliary fuel line 109. When the pressure exceeds a predetermined pressure, for example, an opening pressure of 0.6 bar, filling of the fuel line 101 occurs. The pressure that is necessary for opening the auxiliary fuel line 109 is determined by the spring 119.

Thus, the pressure control valve system 100 comprises two valves which are arranged in fluid-technological opposition to one another, one of which opens in the direction of the fuel line 101 while the other opens in the direction of the initial fill.

The pressure control valve system 100 is formed by recesses in the two molded parts 121 and 123. The two molded parts 121 and 123 have, for example, a cylindrical shape, in the middle of which there is a recess to hold the springs 115 and 119 and the sealing bodies 105 and 111. The pressure control valve system 100 is therefore formed by the interplay between the two molded parts 121 and 123. The molded part 121 comprises a recess for the sealing seat 117 of the sealing body 105. The molded part 123 comprises a cylindrical recess for spring 115.

As springs 115 and 119, screw springs can be used that are wound from spring wire in a cylindrical-, conical- or barrel-shaped form. A torsion is applied to the wire cross-section of the springs upon loading. The spring constant is determined by the properties of the spring wire used. The spring characteristics and the spring constants can be adjusted by areas with variable diameter, variable slope or variable spring diameter, for example in the case of a helical screw spring.

In general, the two molded parts 121 and 123 can have any other shape instead of a cylindrical shape and can be connected to one another in any arbitrary way, for example, they can be welded together. In a different embodiment, a one-part molded part can also be used.

The two molded parts 121 and 123 are arranged in two housing parts 125 and 127, which surround them completely and have connections for the fuel line 101 and the preliminary run. The two housing parts 125 and 127 can be screwed together. For this purpose one of the housing parts 125 may have an outer winding which is not shown and the other housing part 127 may have an inner winding which can be screwed together.

An enclosing seal 129 is arranged between the two housing parts 125 and 127 which prevents the leakage of fuel outwards from the inner pressure control valve system 100. In addition, between the molded part 121 and the housing part 127 and between the molded part 123 and the housing part 125 additional seals 131 and 133, for example sealing rings, are arranged, which also prevent the leakage of the fuel to the outside.

In general, the two housing parts 125 and 127 can have any other suitable shape and can be connected to one another in any arbitrary way, for example, they can be welded together.

The housing of the pressure control valve system 100 has two connections which serve to connect the pressure control valve system 100 with the fuel line 101 so that in case of an excess pressure the fuel can flow through the pressure control valve system 100.

In other embodiments, the molded parts 121 and 123 and the housing parts 125 and 127 can, however, be designed in different ways. Particularly, the molded parts 121 and 123 can be molded together with the housing parts 125 and 127 so that these form a single coherent component. The molded parts 121 and 123, as well as the housing parts 125 and 127 can be manufactured from suitable thermoplastic synthetic materials using the injection-molding method. The use of fiber-reinforced plastics is especially advantageous since these have an especially high strength and pressure resistance.

FIG. 2 shows a side view of the sealing body 105. The sealing body 105 has a cylindrical shaft 113 at the end of which the sealing body head 107 is formed. On the sealing body head 107 a sealing surface 203 is formed which in the closed state of the main fuel line 103 lies tightly against a wall and thus blocks the main fuel line 103. In order to improve the sealing properties, the sealing surface 103 can be provided with a sealing material.

In addition, the sealing body 105 has eight guide lamellae 201 and 207 along its surface which divide the fuel into channels as it flows by. For this purpose, segment-shaped recesses 209 are formed between the guide lamellae 201 and 207. In general, however, the sealing body 105 can also have a different number of guide lamellae 201 and 207.

FIG. 3 shows a cross-sectional view of the sealing body 105. The cross-sectional view runs through two of the guide lamellae 201 and 207. In the center of the sealing body 105 there is a cylindrical channel that forms the auxiliary fuel line 109. There is a funnel-shaped recess 205 in the sealing body head 107, which is connected to the cylindrical channel and serves for accepting the sphere 111. In order to improve the sealing properties, the recess 205 can be lined with a sealing material. The funnel-shaped recess 205 has the advantage that the sphere 111 automatically centers itself inside the recess and thus a good sealing of the auxiliary fuel line 109 is achieved. However, in general the recess 205 can have another form, for example it can be cup-shaped.

The sealing surface 203 on the other sealing body head 107 bows outward so that the latter can close the main fuel line 103 effectively. In the channel of the auxiliary fuel line 109 a filter element or a screen, which is not shown, can also be placed, which serves during the filling of the fuel line 101 to clean the fuel.

FIG. 4 shows a perspective view of the sealing body 105 with the guide lamellae 201 and 207 and the funnel-shaped recess 205. The sealing body 105 can, for example, be made from thermoplastic synthetic material using the injection molding method. In general, however, any other materials can be used that are suitable for the manufacture of the sealing body.

In general, the shape of the sealing body 105 used can deviate from those shown in the figures.

All the individual characteristics explained and depicted in the drawings can combined with one another in any arbitrary, practical manner in order to realize their advantageous effects simultaneously. The pressure control valve systems described and shown can generally be employed in a fuel injection system, in an internal combustion engine or for controlling the flow of other fluids.

### LIST OF REFERENCES

100 pressure control valve system
101 fuel line
103 main fuel line
105 sealing body
107 sealing body head
109 auxiliary fuel line
111 sealing body
113 shaft
115 spring
117 sealing seat
119 spring
121 molded part
123 molded part
125 housing part
127 housing part
129 seal
131 seal
133 seal
201 line
203 sealing surface
205 recess
207 line
209 recess

1. Pressure control valve system for a fuel line comprising:
a main fuel line which can be closed with a spring-loaded sealing body for maintaining a fuel pressure in the fuel line, whereby the first sealing body comprises a sealing body head for sealing the main fuel line, which can be pressed with spring force against a sealing seat,
an auxiliary fuel line formed in the first spring-loaded sealing body for filling the fuel line with fuel, and
a second spring-loaded sealing body provided for closing the auxiliary fuel line.

2. Pressure control valve system according to claim 1, whereby the auxiliary fuel line is an axial bore through the first spring-loaded sealing body.

3. Pressure control valve system according to claim 1, wherein the first spring-loaded sealing body comprises a cylindrical shaft that extends into the sealing body head and a spring, that surrounds the cylindrical shaft and acts on the sealing body head.

4. Pressure control valve system according to claim 1, wherein the sealing body head has a mushroom-shape with rotational symmetry.

5. Pressure control valve system according to claim 1, wherein the auxiliary fuel line comprises a sealing seat for holding the second spring-loaded sealing body.

6. Pressure control valve system according to claim 1, wherein an outer wall of the first spring-loaded sealing body has at least one axial line for conducting fuel.

7. Pressure control valve system according to claim 1, wherein the second spring-loaded sealing body is formed by a sealing sphere.

8. Pressure control valve system according to claim 1, wherein a spring is provided to act on the second spring-loaded sealing body to close the auxiliary fuel line.

9. Pressure control valve system according to claim 1, wherein the main fuel line (103) as well as and the auxiliary fuel line are formed as one molded body and wherein the first spring-loaded sealing body and the second spring-loaded sealing body can be displaced axially in the molded body.

10. Pressure control valve system according to claim 1, wherein the spring force acting on the first sealing body is smaller than the spring force acting on the second sealing body.
